(19) United States
(12) Patent Application Publication
(10) Pub. No.: US 2025/0025991 A1
(43) Pub. Date: Jan. 23, 2025

(54) RATCHETING WRENCH HEAD AND HANDLE ASSEMBLY

(71) Applicant: MATCO TOOLS CORPORATION, Stow, OH (US)

(72) Inventor: Darius S. ADIBI, Lyndhurst, OH (US)

(21) Appl. No.: 18/531,832

(22) Filed: Dec. 7, 2023

Related U.S. Application Data
(60) Provisional application No. 63/527,422, filed on Jul. 18, 2023.

(51) Int. Cl. B25B 23/00; B25B 13/46

(52) U.S. Cl. CPC B25B 23/0028; B25B 13/46

(57) ABSTRACT

The present disclosure is of an assembly between the drive head of a ratcheting wrench and a ratcheting wrench handle. A fastener is provided between the drive head and the handle. The drive head is pivotably connected to the handle by the fastener. The fastener is inserted through apertures of the drive head and the handle. The fastener is threaded at one end. An aperture of the handle is correspondingly threaded. The threads of the fastener and/or the handle do not extend the entire length of the aperture. The aperture with the thread may further have an unthreaded counterbore. The unthreaded counterbore mates with or abuts directly against an unthreaded portion of the fastener.

### BACKGROUND

This disclosure relates generally to ratcheting wrenches or sockets and, more specifically, the assembly between the drive head of a ratcheting wrench and a wrench handle.

A ratcheting wrench typically embodies a handle portion and a drive head portion. The drive head houses a ratchet mechanism capable of applying torque in one direction of rotation and rotating about an axis in an opposite direction of rotation via a ratchet drive. The ratchet drive may be positioned within the drive head portion of the ratchet and include a drive mechanism which may be fitted to the end of a fastener or is a drive square onto which a socket may engage or attach. The ratchet drive may further include a gear capable of reciprocating within the drive head portion in response to the manual driven operation of the ratchet. The drive mechanism is formed on or attached to gears for operation.

A ratcheting wrench may be manually operated. The torque or rotation may be applied to the drive head assembly by the wrench handle. While some handles are a direct extension of the drive head assembly of a ratcheting wrench, other ratcheting wrenches have handles that further translate, pivot, or move, at a connection between the drive head and the handle. Because the force to operate the ratcheting mechanism is translated from the handle to the drive head, the connection or transition between the drive head and the handle receives a great deal of stress and has been found to be a common point of failure.

Specifically, ratcheting wrenches are relied on to provide a significant amount of torque from the handle into the drive mechanism when in operation. The stresses imposed on the ratcheting wrench in such conditions translate through any transitions or connections between the handle and the drive head. Specifically, such failures may be attributed to isolated stress failures, or fractures, or point loads of the components connecting the handle to the drive head. What is needed is a more robust connection between the handle and the drive head of a ratcheting wrench.

### SUMMARY

The present disclosure sets forth an assembly between the drive head and a ratcheting handle of a ratcheting wrench that withstands stresses imposed on the connection between the drive head and the handle, while still allowing the ratcheting wrench handle to pivot relative to the ratcheting wrench drive head. Further yet, the ratcheting wrench assembly of the present disclosure is repairable in the field without use of larger or floor mounted shop devices, such as a hydraulic press.

The ratcheting wrench assembly of the present disclosure comprises a drive head and a handle. The drive head comprises a drive mechanism and an extension. The handle comprises one or more legs. The drive head is pivotably connected to the handle by a fastener. The fastener extends through an aperture of each of the one or more legs and an aperture of the extension. The fastener comprises a shank. A first end of the shank comprises threads, the threads of the fastener extend a partial length of the aperture of one of the one or more legs. The threads of the fastener mate with threads on a surface of the aperture of the one of the one or more legs receiving the first end of the shank.

The ratcheting wrench assembly of the present example may further comprise a counterbore. In one example, the counterbore may be a threaded counterbore. In another example the counterbore may be an unthreaded counterbore. In some examples, the ratchet wrench assembly may comprise multiple counterbores that may be unthreaded, threaded, or a combination of unthreaded and threaded. By example, a ratchet wrench assembly may have a first counterbore as identified in the example of FIG. 4, below, and a second counterbore as identified in the example of FIG. 5, below. An example comprising multiple counterbores may be threaded as arranged in FIG. 4, below, and/or threaded as arranged in FIG. 5 below.

In the example comprising an unthreaded counterbore, the aperture of the one or more legs receiving the first end of the shank may comprise said unthreaded counterbore. The unthreaded counterbore may receive an unthreaded section of the shank. The unthreaded counterbore may be positioned adjacent the extension of the drive head. The unthreaded counterbore may directly mate with or directly abut an unthreaded surface of the shank of the fastener within the aperture of the leg receiving the first end of the shank. The threads of the surface of the aperture may have a smaller diameter than the unthreaded counterbore. The threads of the surface of the aperture and the threads of the shank may be separated from the extension of the drive head by the unthreaded counterbore. The inside diameter of the unthreaded counterbore may be the same as an outside diameter of the shank of the fastener, forming an interference between said components. The outside diameter of the shank may be constant aside from the threads of the shank. The inside diameter of the aperture of the one or more legs is the same and constant aside from the threads on the surface of the aperture. In examples, the threads of the shank and the threads on the surface of the aperture do not extend a full length of the aperture of the leg receiving the first end of the shank.

In the example comprising a threaded counterbore, the aperture of the one or more legs receiving the first end of the shank may comprise said threaded counterbore. The threaded counterbore may receive a threaded section of the shank. The threaded counterbore may be positioned adjacent the extension of the drive head. The threaded counterbore may thread into a threaded surface of the shank of the fastener within the aperture of the leg receiving the shank. The unthreaded of the surface of the aperture may have a smaller diameter than the threaded counterbore. The threads of the surface of the aperture and the threads of the shank may be separated from the extension of the drive head by a length of the unthreaded aperture and shank. The outside diameter of the shank may be constant aside from the threaded section of the shank. The inside diameter of the aperture of the one or more legs is the same and constant aside from the threads on the threaded counterbore of the aperture. In examples, the threads of the shank and the threads on the surface of the aperture do not extend a full length of the aperture of a respective leg or a corresponding length of the shank mating therewith.

In another example, a ratcheting wrench assembly of the present disclosure comprises a drive head and a handle. The drive head comprises a drive mechanism and an extension. The handle comprises two legs. A handle recess is formed between the two legs and separates the two legs of the handle. The drive head is pivotably connected to the handle by the fastener. The fastener extends through an aperture of each of the two legs and an aperture of the extension. The extension is positioned within the handle recess. The fastener comprises a shank. A first end of the shank comprises threads. The threads of the fastener extend a partial length of the aperture of one of the two legs receive the first end of the shank.

The ratcheting wrench assembly of the present example may further comprise an unthreaded counterbore. The aperture of the two legs receiving the first end of the shank may comprise said unthreaded counterbore. The unthreaded counterbore may receive an unthreaded section of the shank. The unthreaded counterbore may be positioned adjacent the recess of the handle. The unthreaded counterbore may directly mate with or directly abut an unthreaded surface of the shank of the fastener within the aperture of the leg receiving the first end of the shank. The threads of the surface of the aperture may have a smaller diameter than the unthreaded counterbore. The threads of the surface of the aperture and the threads of the shank may be separated from the extension of the drive head and/or the recess of the handle by the unthreaded counterbore. The inside diameter of the unthreaded counterbore may be the same as an outside diameter of the shank of the fastener, forming an interference between said components. The outside diameter of the shank may be constant aside from the threads of the shank. The inside diameter of the apertures of the two legs are the same and constant aside from the threads on the surface of the aperture. In examples, the threads of the shank and the threads on the surface of the aperture do not extend a full length of the aperture of the leg receiving the first end of the shank.

In the examples of the present disclosure, the ratcheting wrench assembly may comprise a fastener that completely fills the aperture(s) of each of the legs and the aperture of the extension. In examples of the present disclosure, the fastener of the ratcheting wrench assembly may comprise a screw head for receiving a hand tool at a second end of the shank opposite the first end of the shank, for insertion and/or removal of the fastener into the ratcheting wrench assembly.

The foregoing and other objects, features, and advantages of the examples will be apparent from the following more detailed descriptions of particular examples as illustrated in the accompanying drawings wherein like reference numbers represent like parts of the examples.

### BRIEF DESCRIPTION OF THE DRAWINGS

Reference is made to the accompanying drawings in which particular examples and further benefits of the examples are illustrated as described in more detail in the description below, in which:

FIG. 1A is a cross-section of a ratcheting wrench assembly of the prior art.

FIG. 1B is a cross-section of a ratcheting wrench assembly of the prior art.

FIG. 2 is a ratcheting wrench assembly, in accordance with an example of the disclosure.

FIG. 3 is an exploded view of the ratcheting wrench assembly of FIG. 2, in accordance with an example of the disclosure.

FIG. 4 is a cross-section of the ratcheting wrench assembly taken at line 4-4 of FIG. 2, in accordance with an example of the disclosure.

FIG. 5 is a cross-section of a ratchet wrench assembly taken at line 4-4 of a wrench like that described by FIG. 2, in accordance with another example of the disclosure.

### DETAILED DESCRIPTION

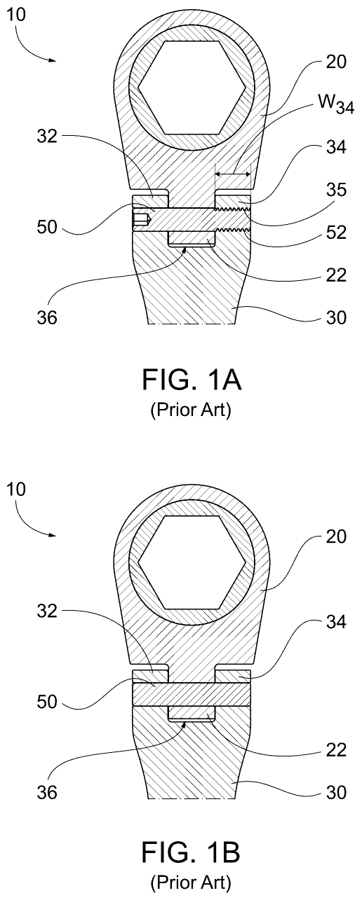

The present disclosure relates generally to ratcheting wrenches and, more specifically, the assembly between a drive head of a ratcheting wrench and a handle of a ratcheting wrench. FIGS. 1A-1B illustrate prior art ratcheting wrench assemblies. FIGS. 1A-1B are cross-sections of ratcheting wrench assemblies 10. In FIGS. 1A-1B, a drive head 20 is connected to a handle 30 by a fastener 50.

In FIG. 1A, the fastener 50 is a threaded fastener that extends through both the drive head 20 and the handle 30. The fastener 50 is removably threaded into the handle 30 to pivotably connect the drive head 20 to the handle 30. Specifically, the fastener 50 extends through two opposing legs 32, 34 of the handle 30 with a recess 36 therebetween. A head extension 22 of the drive head 20 is positioned within the recess 36 between the two opposing legs 32, 34 of the handle 30. The fastener 50 is inserted and extends through an aperture in each opposing leg 32, 34 and an aperture of the head extension 22 of the drive head 20.

Still referring to FIG. 1A, one leg 34 of the opposing legs 32, 34 have threads 35 that mate with corresponding threads 52 of the fastener 50. As illustrated by FIG. 1A, the threads 35 of the leg 34 and the threads 52 of the fastener 50 extend the full width W₃₄ of the respective leg 34. Accordingly, the threads 52 of the fastener 50 terminate at the transition between the leg 34 of the handle 30 and the head extension 22 of the drive head 20. Because threads 52 of the fastener 50 are cut into and recessed within the shank of the fastener 50, material failures (e.g., stress fractures, stress failures, etc.) arise at the threaded transition that rests directly at the point load that arises between the transition between the leg 34 and the head extension 22.

A fastener 50 that is a press fit pin may be provided at this location to overcome this shortcoming, such as the ratcheting wrench assembly 10 illustrated by FIG. 1B. In FIG. 1B, no threads are present. Instead, FIG. 1B illustrates a fastener 50 that is a press fit pin having a constant diameter. The press fit pin fastener 50 is inserted through the two opposing legs 32, 34 and the head extension 22 by force of a hydraulic press. The press fit pin fastener 50 is thereby permanently affixed within the two opposing legs 32, 34. While the press fit pin fastener 50 of FIG. 1B does not possess the recessed threads that give rise to the point load failure, as described relative to the example of FIG. 1A, the press fit pin fastener 50 is permanent, and cannot be removed or replaced in the field. Thereby, a press fit pin fastener 50 of FIG. 1A greatly reduces the availability for maintenance of a ratcheting wrench assembly 10 in the field where a hydraulic press is not otherwise available.

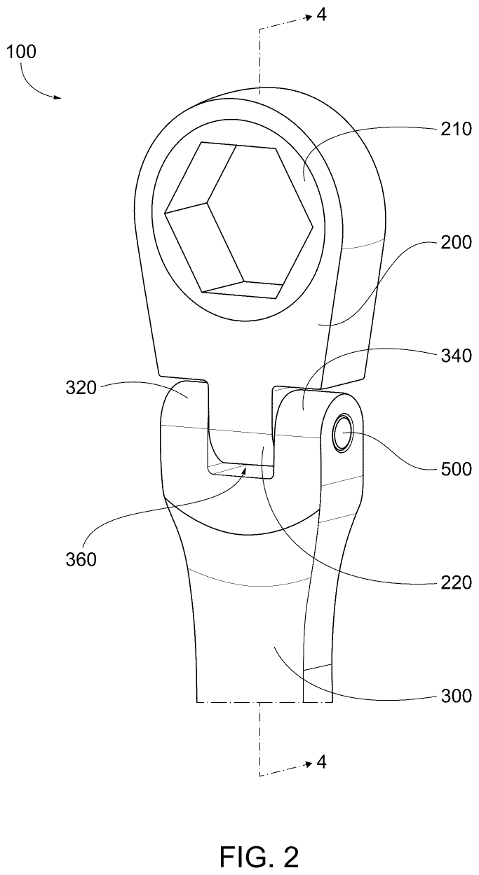

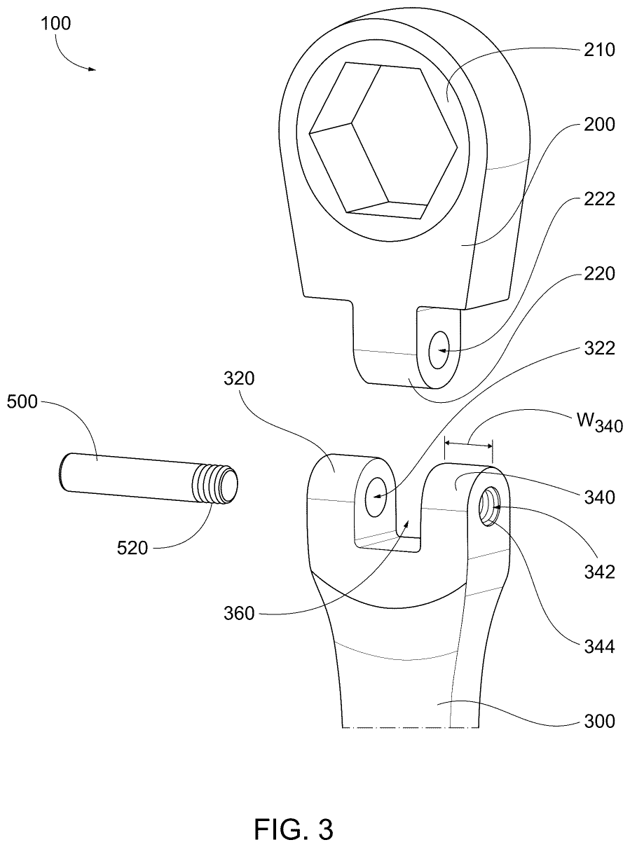

Turning now to FIG. 2, FIG. 2 illustrates a ratcheting wrench assembly 100 of the present disclosure. The ratcheting wrench assembly 100 of FIG. 2 comprises a drive head 200 connected to a handle 300 by a fastener 500. The fastener 500 extends through two opposing legs 320, 340 of the handle 300, with a recess 360 formed therebetween. An extension 220 of the drive head 200 is positioned between the two opposing legs 320, 340 within the recess 360. The fastener 500 additionally extends through the extension 220 of the drive head 200. The fastener 500 extends through apertures 322, 342 (as illustrated by FIG. 3) of each leg 320, 340 of the handle 300 and an aperture 222 (as illustrated by FIG. 3) of the extension 220 of the drive head, such that the drive head 200 may, at least, partially pivot relative to the handle at the fastener 500.

FIG. 3 further illustrates an exploded view of the ratcheting wrench assembly 100 of FIG. 2. Like FIG. 2, the ratcheting wrench assembly of FIG. 3 comprises a drive head 200 meant to be connected to a handle 300 by a fastener 500. Upon assembly, the fastener 500 extends through two opposing legs 320, 340 of the handle 300, a recess 360 formed between the two opposing legs 320, 340 of the handle 300. An extension 220 of the drive head 200 is positioned between the two opposing legs 320, 340 within the recess 360, when assembled. The fastener 500 additionally extends through the extension 220 of the drive head 200, when assembled. Specifically, the fastener 500 extends through apertures 322, 342 of each leg 320, 340 of the handle 300 and an aperture 222 of the extension 220 of the drive head, such that the drive head 200 may, at least, partially pivot relative to the handle at the fastener 500.

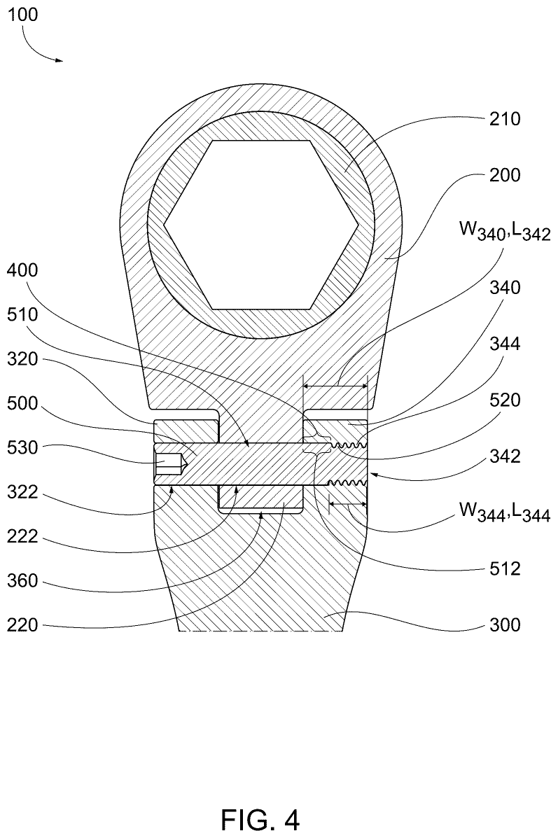

As further illustrated by FIG. 3, the fastener 500 is a threaded fastener 500 comprising threads 520. Accordingly, an aperture 342 of at least one leg 340 of the handle 300 is additionally threaded with threads 344 for receiving the threads 520 of the threaded fastener 500. As will be further illustrated by FIG. 4, the threads 344, however, do not extend the full width W₃₄₀ of the leg 340. In other words, the threads 344 extend only a partial width W₃₄₄ of the leg 340, when assembled as illustrated by FIG. 2. Similarly, the threads 520 of the threaded fastener 500 also do not extend the full width W₃₄₀ of the leg 340, when assembled. Likewise, the threads 520 extend only a partial width W₃₄₄ of the leg 340, when assembled as illustrated by FIG. 2.

FIG. 4 is a cross-section of the assembled ratcheting wrench assembly 100 of FIG. 2, taken at line 4-4 of FIG. 2. As noted above, FIG. 4 illustrates threads 344 do not extend the full width W₃₄₀ of the respective threaded leg 340. In other words, the threads 344 extend only a partial width W₃₄₄ of the threaded leg 340. It may additionally be stated, threads 344 do not extend the full length L₃₄₂ of the aperture 342 of the respective threaded leg 340 and extend only a partial length L₃₄₄ of the aperture 342 of the respective threaded leg 340. Similarly, the threads 520 of the threaded fastener 500 also do not extend the full width W₃₄₀ of the threaded leg 340. Likewise, the threads 520 extend only a partial width W₃₄₄ of the leg 340. Similarly, it may additionally be stated, threads 520 of the threaded fastener 500 do not extend a full length L₃₄₂ of the aperture 342 of the threaded leg 340 and extend only a partial length L₃₄₄ of the aperture 342 of the respective threaded leg 340. In some examples, the threads 520 of the threaded fastener 500 extend approximately 50% of the aperture 342 of the respective leg. The counterbore may additionally, or alternatively, extend approximately 50% of the aperture 342 of the respective leg.

The threaded aperture 342 of the leg 340 further comprises a counterbore 400 to receive the unthreaded portion of the shank 510 of the fastener 500 received within the threaded aperture 342. The counterbore 400 may additionally be unthreaded. The unthreaded portion of the shank 510 of the fastener received within the threaded aperture 342 is referred to herein as the recessed shank 512. In examples, the recessed shank 512 comprises a constant diameter with the remaining unthreaded portions of the shank 510 extending through the aperture 222 of the extension 220 of the drive head and the aperture 322 extending through the opposing leg 320 of the handle 300. The threads 520 of the fastener 500 are threaded into or recessed within the shank 510 of the fastener.

As further illustrated by FIG. 4, the threads 520 of the fastener 500 of the assembled ratcheting wrench assembly 100 do not terminate at or near the transition between the threaded leg 340 of the handle 300 and the extension 220 of the drive head 200 or, in other words, at the recess 360 of the handle 300. The threads 520 of the fastener 500 and the threads 344 of the threaded aperture 342 of the leg 340 do not extend to the recess 360 of the handle 300. Instead, the threads 520 of the fastener 500 and the threads 344 of the threaded aperture 342 terminate internally within the threaded aperture 342 of the leg 340. The threads 520 of the fastener 500 and the threads 344 of the threaded aperture 342 terminate internally within the threaded aperture 342 of the leg 340 at the counterbore 400, otherwise concealed within the aperture 342 of the leg 340 when assembled. In some examples, the threads 520 of the fastener 500 and the threads 344 of the threaded aperture 342 terminate centrally within the threaded aperture 342 of the leg 340 at the counterbore 400. The recessed shank 512 of the fastener is recessed partially within the threaded aperture 342 of the leg 340 such that the recessed shank 512 abuts the counterbore 400. By examples, the surface(s) of the shank engage the surface of the counterbore.

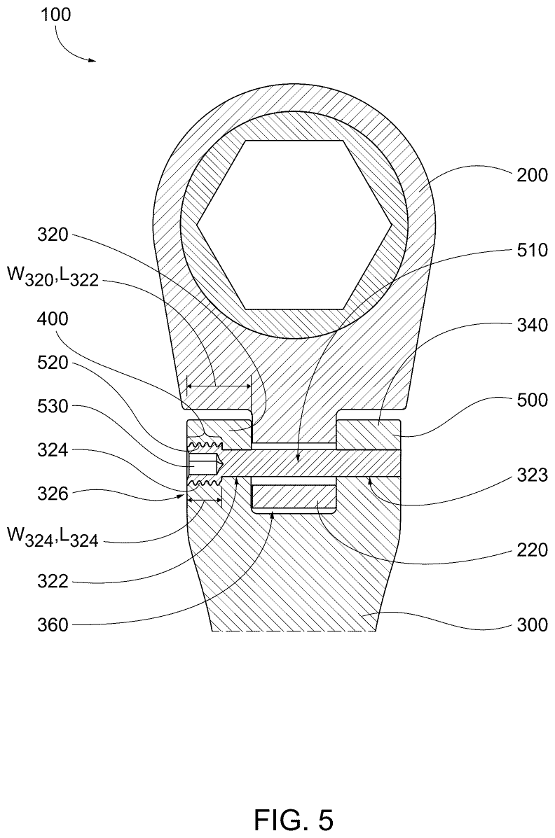

Still referring to FIG. 4, the fastener 500 comprising a recessed shank 512, recessed within a counterbore 400, may further comprise a screw head 530 that may receive a tool for assembly or removal of the fastener 500 from the ratcheting wrench assembly 100. The ratcheting wrench assembly 100 of the present disclosure may, therefore, undergo maintenance and is repairable in the field, at a location where a hydraulic press might not otherwise be available. Accordingly, it has been found that the fastener 500 of the present disclosure combines the strength of a press fit pin with the repairability of a threaded fastener. Additional arrangements, accomplishing the similar objectives, are further contemplated herein. FIG. 5 is another example of an assembled ratcheting wrench assembly 100. FIG. 5 is a cross-section of an assembled ratcheting wrench assembly 100 like that of FIG. 2, taken at line 4-4 of FIG. 2, but with a different fastener 500 and counterbore 400 arrangement. In FIG. 5, a counterbore 400 is provided at an exterior surface 326 of first leg 320. Like that of FIG. 4, FIG. 5 illustrates threads 324 do not extend the full width W₃₂₀ of a leg, and in the instance of FIG. 5, are provided opposite the recess 360 of the handle 300 in the first leg 320. In other words, the threads 324 extend only a partial width W₃₂₄ of the first leg 320 but terminate internally within a counterbore 400. It may additionally be stated, threads 324 do not extend the full length L₃₂₂ of the aperture 322 of the respective first leg 320 and extend only a partial length L₃₂₄ of the aperture 322 of the respective first leg 320. In some examples, the threads 324 of the fastener 500 extend approximately 50% of the aperture 322 of the respective leg. The counterbore 400 may additionally, or alternatively, extend approximately 50% of the aperture 322 of the respective leg.

The shank 510 of the fastener 500 of FIG. 5 is otherwise at a constant dimension, or constant diameter, aside from the section received by the threaded counterbore 400. Like the example of FIG. 4, this arrangement separates the threads 324 from the transition, or intersection, between the legs 320, 340 and the extension 220 of the drive head 200. In other words, the threads 520 of the fastener 500 of the assembled ratcheting wrench assembly 100 of FIG. 5 do not terminate at, or near, the transition, or intersection, between the first leg 320 of the handle 300 and the extension 220 of the drive head 200 (or the second leg 340 of the handle 300 and the extension 220 of the drive head 200). Accordingly, the threads 520 of the fastener 400 do not extend to the transition at the recess 360 of the handle 300 that failure has otherwise been exhibited in the prior art examples. Instead, the threads 520 of the fastener 500 and the threads 324 of the threaded aperture 322 terminate internally within the threaded aperture 322 of the first leg 320, which happens to additionally be the counterbore 400 of the example of FIG. 5. In contrast to FIG. 4, the counterbore 400 of FIG. 5 is not otherwise concealed within the respective aperture 322 of the first leg 320 when assembled. Instead, the counterbore 400 is provided at a screw head 530 that may receive a tool for assembly or removal of the fastener 500 from the ratcheting wrench assembly 100. In the example of FIG. 5, the dimension of the remainder of shank 510 (e.g., diameter of the shank) of the fastener 500 is smaller than the counterbore 400 comprising the threads 324 of the threaded aperture 322 corresponding to the section comprising the threads 520 of the fastener 500.

In FIG. 5, the remainder of apertures 322, 323, that do not comprise the counterbore 400, are unthreaded. However, it is contemplated herein that an example may comprise a combination of the example of FIG. 4 and FIG. 5, wherein another counterbore and/or threads may be provided on the second leg 340. By example, a second counterbore may be of the same dimension as the aperture 322 and/or of the shank 510 extending beyond the counterbore 400 through the first leg 320 of FIG. 5. Accordingly, threads may be provided at the second/threaded leg 340, as illustrated and described by FIG. 4. The threaded aperture 342 of the leg 340 may further comprise a counterbore 400 to receive the unthreaded portion of the shank 510 of the fastener 500 received adjacent the threaded aperture 342, as also illustrated and described by FIG. 4. In yet another variation of such an example, the counterbore 400 of FIG. 5 may be unthreaded, thereby, comprising two counterbore sections with only a single threaded section, such as the threaded section illustrated by FIG. 4. Further yet, the counterbore 400 of FIG. 5 may be unthreaded and be used as a press fit pin, wherein no threads are provided on the shank of the fastener and/or apertures of the legs.

It is emphasized that, in both of the examples of FIGS. 4 and 5, the threads of the fastener of the assembled ratcheting wrench assembly, or any transition in dimension of the shank of the fastener, do not terminate at or occur adjacent the transition between any respective leg of the handle and the extension of the drive head and/or at the recess of the handle. In both examples, the threads of the fastener and the threads of the threaded aperture of the respective leg do not extend to the recess of the handle. Instead, the threads of the fastener and the threads of the threaded aperture terminate internally within a threaded aperture of a respective leg. The threads of the fastener and the threads of the threaded aperture terminate internally within the threaded aperture of the leg, regardless of whether the counterbore receives the remainder of the shank of the fastener (as in FIG. 4) or the counterbore possesses the threads to receive the threads of the fastener (as in FIG. 5). In the examples of both FIGS. 4 and 5, the threads of the fastener and the threads of the threaded aperture terminate centrally within the threaded aperture of the respective leg. This simply illustrates each example may be further modified to capture the intent of the present disclosure wherein threads of a shank do not terminate at a transition between a handle and an extension of a drive head.

While the present examples are described and illustrated with respect to ratchet wrench assembly it is contemplated herein the same may be applied to other flex head ratchets such as, for example, socket wrenches, hand powered drivers, or the like. While the above examples may apply to large wrenches (e.g., 8 mm-27 mm drive wrenches), it is contemplated herein the above examples may apply to wrenches of any size.

While this invention has been described with reference to examples thereof, it shall be understood that such description is by way of illustration only and should not be construed as limiting the scope of the claimed examples. Accordingly, the scope and content of the examples are to be defined only by the terms of the following claims. Furthermore, it is understood that the features of any example discussed herein may be combined with one or more features of any one or more examples otherwise discussed or contemplated herein unless otherwise stated.

What is claimed is:

1. A ratcheting wrench assembly comprising:
a drive head comprising a drive mechanism and an extension;
a handle comprising one or more legs;
the drive head pivotably connected to the handle by a fastener, the fastener extending through an aperture of each of the one or more legs and an aperture of the extension; and
the fastener comprising a shank with a first end of the shank comprising threads, the threads extend a partial length of the aperture of one of the one or more legs wherein the threads of the fastener mate with threads on a surface of the aperture of the one of the one or more legs receiving the first end of the shank.

2. The ratcheting wrench assembly of claim 1 wherein the one or more legs is two legs with a handle recess between the two legs, the fastener extends through the apertures of each of the two legs and the aperture of the extension, and the extension is positioned within the handle recess.

3. The ratcheting wrench assembly of claim 2 wherein the aperture of the two legs receiving the first end of the shank further comprises a counterbore for receiving a section of the shank.

4. The ratcheting wrench assembly of claim 3 wherein the counterbore is unthreaded counterbore and the unthreaded counterbore is positioned adjacent the handle recess.

5. The ratcheting wrench assembly of claim 3 wherein the unthreaded counterbore directly mates with or directly abuts an unthreaded surface of the shank of the fastener within the aperture of the leg receiving the first end of the shank.

6. The ratcheting wrench assembly of claim 3 wherein an inside diameter of the unthreaded counterbore is the same as an outside diameter of the shank of the fastener.

7. The ratcheting wrench assembly of claim 3 wherein an outside diameter of the shank is constant aside from the threads of the shank.

8. The ratcheting wrench assembly of claim 3 wherein an inside diameter of the apertures of the two legs are the same and constant aside from the threads on the surface the aperture.

9. The ratcheting wrench assembly of claim 3 wherein the threads of the shank and the threads on the surface of the aperture do not extend a full length of the aperture of the leg receiving the first end of the shank.

10. The ratcheting wrench assembly of claim 1 wherein the aperture of the one or more legs receiving the first end of the shank further comprises an unthreaded counterbore for receiving an unthreaded section of the shank.

11. The ratcheting wrench assembly of claim 10 wherein the unthreaded counterbore is positioned adjacent the extension of the drive head.

12. The ratcheting wrench assembly of claim 10 wherein the threads of the surface of the aperture have a smaller diameter than the unthreaded counterbore.

13. The ratcheting wrench assembly of claim 10 wherein the threads of the surface of the aperture and the threads of the shank are separated from the extension of the drive head by the unthreaded counterbore.

14. The ratcheting wrench assembly of claim 10 wherein the unthreaded counterbore directly mates with or directly abuts an unthreaded surface of the shank of the fastener within the aperture of the one of the one or more legs receiving the first end of the shank.

15. The ratcheting wrench assembly of claim 10 wherein an inside diameter of the unthreaded counterbore is the same as an outside diameter of the shank of the fastener.

16. The ratcheting wrench assembly of claim 10 wherein an outside diameter of the shank is otherwise constant aside from the threads of the shank.

17. The ratcheting wrench assembly of claim 10 wherein an inside diameter of each of the apertures of the one or more legs are the same and constant aside from the threads on the surface the aperture.

18. The ratcheting wrench assembly of claim 10 wherein the threads of the shank and the threads on the surface of the aperture do not extend a full length of the aperture of the leg of the one or more legs receiving the first end of the shank.

19. The ratcheting wrench assembly of claim 1 wherein the fastener further comprises a screw head for receiving a tool at a second end of the shank opposite the first end of the shank.

20. The ratcheting wrench assembly of claim 1 wherein the fastener completely fills the aperture of each of the one or more legs and the aperture of the extension.
